(19) United States
(12) Patent Application Publication
(10) Pub. No.: US 2002/0054206 A1
(43) Pub. Date: May 9, 2002

(54) Systems and devices for audio and video capture and communication during television broadcasts

(76) Inventor: Paul G. Allen, Mercer Island, WA (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/967,730

(22) Filed: Sep. 27, 2001

Related U.S. Application Data
(63) Continuation-in-part of application No. 09/707,072, filed on Nov. 6, 2000.

(51) Int. Cl. H04N 7/14; H04N 7/173

(52) U.S. Cl. 348/14.04; 725/133

(57) ABSTRACT

A remote control for an interactive television system includes an integrated microphone and a wireless transmitter for transmitting audio signal captured by the microphone to the interactive television system. The remote control also includes a specifically-designated button or button sequence for activating the microphone. In alternative embodiments, the microphone is integrated with a set top box for the interactive television system.

### RELATED APPLICATIONS

This application is a continuation-in-part of U.S. patent application Ser. No. 09/707,072, filed Nov. 6, 2000, for “Systems and Devices for Audio Capture and Communication During Television Broadcasts,” with inventor Paul. G. Allen, which is hereby incorporated by reference in its entirety.

### BACKGROUND OF THE INVENTION

1. Field of the Invention

The present invention relates generally to the field of interactive television systems. More specifically, the present invention relates to systems and devices for audio and video capture and communication during television broadcasts.

2. Description of the Background Art

Television watching is an immensely popular pastime throughout the world. Indeed, one or more televisions may be found in virtually every residence in the United States and most developed countries.

For many people, the television viewing experience is enhanced by watching television programs with others. Thus, typical residences are equipped with numerous seats in front of a television to accommodate several family members and friends. Certain television programs are more frequently viewed in the company of others. For example, sporting events, television premieres, political debates, and other significant television broadcasts are typically viewed by groups of people.

Often it is inconvenient for viewers to be physically present in the same room due to geographical distances, conflicting schedules, short notice, and other limitations. In such instances, viewers may watch a television program individually and then meet at a later time to discuss the program. Alternatively, viewers may teleconference (e.g., call each other on a telephone) during an ongoing television program for a more interactive discourse. Unfortunately, conventional teleconferencing presents a number of disadvantages.

For example, extended teleconferencing during a broadcast may deprive other household members of the use of a telephone. Moreover, a telephone may not be easily accessible at the viewer's location, and relocating a telephone to the viewer's location may be difficult or inconvenient, particularly after a program has commenced. In addition, teleconferencing may be expensive, particularly where more than two parties are connected simultaneously.

Thus, it would be an advancement in the art to provide a convenient technique for conversing during a television broadcast with one or more other viewers at remote physical locations. It would be a further advancement in the art to provide a cost-effective system for audio and video conferencing which provides minimal disruption of the television program being viewed.

### BRIEF DESCRIPTION OF THE DRAWINGS

Non-limiting and non-exhaustive embodiments of the present invention are described in the Figures, in which

FIG. 1 is a block diagram of a communication network;

FIG. 2 is a block diagram of an interactive television system according to an embodiment of the invention;

FIG. 3 is a block diagram of a set top box (STB) according to an embodiment of the invention;

FIG. 4 is a plan view of a remote control according to an embodiment of the invention;

FIG. 5 is a block diagram of an interactive television system according to an alternative embodiment of the invention;

FIG. 6 is a block diagram of an STB according to an alternative embodiment of the invention;

FIG. 7 is a plan view of a remote control according to an alternative embodiment of the invention; and

FIG. 8 is a flowchart of a method for audio and video capture and communication according to an embodiment of the invention.

### DETAILED DESCRIPTION OF THE PREFERRED EMBODIMENTS

The present invention provides systems, methods, and devices that overcome the above-described problems and disadvantages. In one embodiment, a remote control for an interactive television system includes an integrated microphone and a wireless transmitter for capturing and transmitting an audio signal to the interactive television system. Optionally, the remote control also includes a video camera for capturing a video signal, which may be similarly transmitted to the interactive television system.

The remote control may include a specifically-designated button for activating the microphone and/or the camera. Alternatively, at least one specifically-designated sequence of buttons may be used for the same purpose. For instance, one or more navigational buttons on the remote control may be used to select an onscreen control for activating the microphone and/or the camera.

In certain implementations, a set top box (STB) for the interactive television system includes a wireless receiver for receiving the audio and/or video signal sent by the remote control. The set top box further includes a converter for transforming the audio and/or video signal into an audio and/or video stream capable of being transmitted over a network, such as the Internet, a cable television network, or a direct satellite broadcast (DBS) network.

In an alternative embodiment, the STB, itself, includes an integrated microphone and/or video camera in lieu of, or in addition to, the microphone and/or video camera integrated with the remote control. In such an embodiment, the specifically-designated button (or button sequence) on the remote control may be used to activate the microphone and/or video camera within the STB.

The STB may receive audio and/or video streams via the network from another STB or other communication device, such as a videophone, webphone, or the like. The converter within the STB may then convert the received audio and/or video stream into audio and/or video signals, which may be reproduced by the interactive television system. During the exchange and playback of the audio and/or video signals, viewers may watch television programs and converse with one another, enhancing the television viewing experience.

In the following description, numerous specific details are provided, such as examples of programming, user selections, transactions, etc., to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

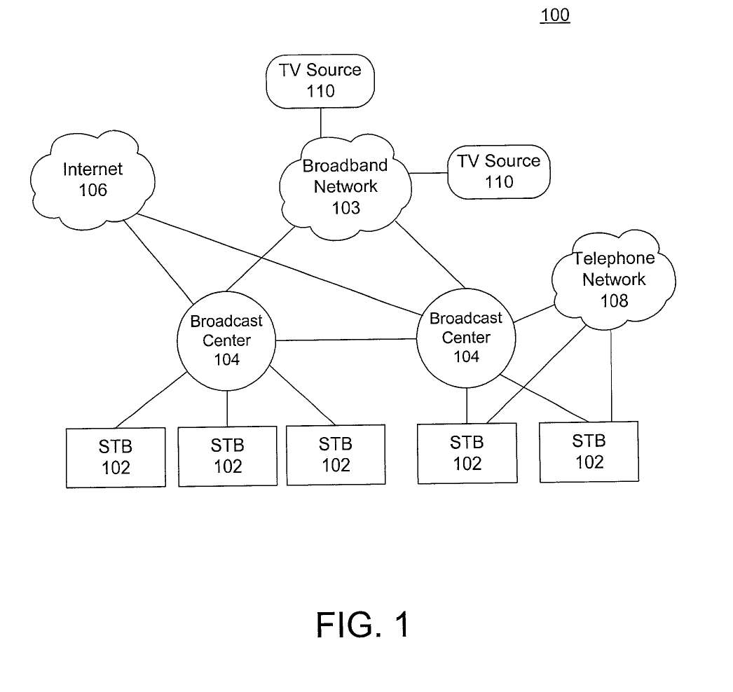

Referring now to FIG. 1, there is shown a communication network 103 for distributing television programming and other content to a number of customers. In one implementation, the network 103 includes a plurality of set top boxes (STBs) 102 located, for instance, at customer homes or offices. Generally, an STB 102 is consumer electronics device that serves as a gateway between a customer's television and a broadband network 103, such as a cable television network or a direct satellite broadcast (DBS) network. As such, an STB 102 is typically located on top of, or in close proximity to, a customer's television.

In one embodiment, an STB 102 receives encoded television signals and other data from the network 108 and decodes the same for display on the television. Additionally, an STB 102 receives user input (typically via a remote control) and transmits the same back to the network 103.

In various embodiments, each STB 102 is connected to a broadcast center 104. In the context of a cable television network, a broadcast center 104 may be embodied as a “head-end”, which is a centrally-located facility where television programming is received from a local satellite downlink and packaged for transmission to the STBs 102. The broadcast center 104 may also function as a Central Office (CO) in the telecommunication industry, routing audio and video streams and other data to and from the various STBs 102 serviced thereby.

Alternatively, a broadcast center 104 may be embodied as a satellite broadcast center within a DBS system. A DBS system may utilize a small 18-inch satellite dish, which is an antenna for receiving a satellite broadcast signal. Each STB 102 may be integrated with a digital integrated receiver/decoder (IRD), which separates each channel, and decompresses and translates the digital signal from the satellite dish to be displayed by the television.

Programming for a DBS system may be distributed, for example, by multiple high-power satellites in geosynchronous orbit, each with multiple transponders. Compression (e.g., MPEG) may be used to increase the amount of programming that can be transmitted in the available bandwidth.

The broadcast centers 104 may be used to gather programming content, ensure its digital quality, and uplink the signal to the satellites. Programming may be received by the broadcast centers 104 from content providers (CNN, ESPN, HBO, TBS, etc.) via satellite, fiber optic cable and/or special digital tape. Satellite-delivered programming is typically immediately digitized, encrypted and uplinked to the orbiting satellites. The satellites retransmit the signal to every earth-station, e.g., every compatible DBS system receiver dish at customer homes and businesses.

Some broadcast programs may be recorded on digital videotape in the broadcast center 104 to be broadcast later. Before any recorded programs are viewed by customers, technicians may use post-production equipment to view and analyze each tape to ensure audio and video quality. Tapes may then be loaded into a robotic tape handling systems, and playback may be triggered by a computerized signal sent from a broadcast automation system. Back-up videotape playback equipment may ensure uninterrupted transmission at all times.

Regardless of the nature of the network 103, the broadcast centers 104 may be coupled directly to one another or through the network 103. In alternative embodiments, one or more broadcast centers 104 may be connected via a separate network, such as the Internet 106 or a telephone network 108. The Internet 106 is a “network of networks” and is well known to those skilled in the art. Communication over the Internet 106 is accomplished using standard protocols, such as TCP/IP (Transmission Control Protocol/Internet Protocol) and the like. The telephone network 108 may be embodied as a conventional public switched telephone network (PSTN), digital subscriber line (DSL) network, or the like.

A broadcast center 104 may receive television programming for distribution to the STBs 102 from one or more television programming sources 110 coupled to the network 103. Preferably, television programs are distributed in an encoded format, such as MPEG (Moving Picture Experts Group). Various MPEG standards are known, such as MPEG-2, MPEG-4, MPEG-7, and the like. Thus, the term “MPEG,” as used herein, contemplates all MPEG standards. Moreover, other video encoding/compression standards exist other than MPEG, such as JPEG, JPEG-LS, H.261, and H.263. Accordingly, the invention should not be construed as being limited only to MPEG.

As described in greater detail below, an STB 102 may transmit audio and/or video streams to one or more other STBs 102 connected to the network 103. The communication path for the transmission may involve one or more broadcast centers 104 or networks (e.g., the broadband network 103, the Internet 106, or the telephone network 108).

For example, a first STB 102 may send an audio transmission upstream to a first broadcast center 104, then to a second broadcast center 104, and finally downstream to a second STB 102. The transmission may be encoded in various formats, such as MPEG or Voice over IP (VoIP).

Each STB 102 may be identified by a unique number, code or address, such as an Internet Protocol (IP) address or Media Access Control (MAC) address. Thus, a user of a first STB 102 may specify the address of a second STB 102 to receive the audio and/or video transmission, after which the transmission is automatically routed to its destination using conventional techniques.

Of course, the communication system 100 illustrated in FIG. 1 is merely exemplary, and other types of devices and networks may be used within the scope of the invention.

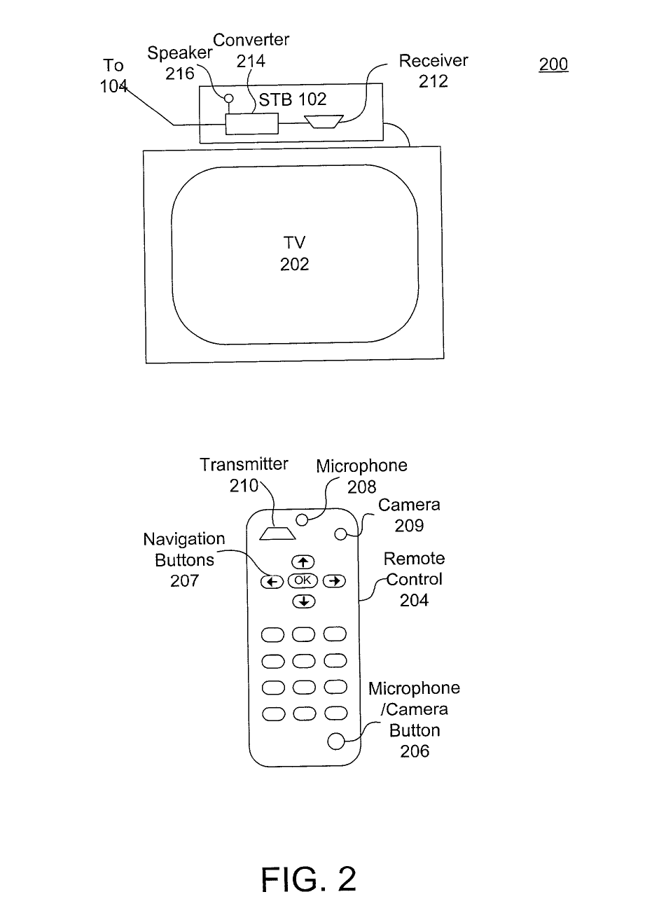

Referring now to FIG. 2, there is shown an interactive television system 200 according to an embodiment of the invention. In one implementation, the system 200 includes an STB 102, as discussed above, for selectively receiving and television signal from a television programming source 110. In addition, the system 200 may include a television 202, which is configured to receive and display the television signal.

A remote control 204 may also be provided for convenient remote operation of the STB 102 and television 202. As described below, the remote control 204 may communicate with the STB 102 and television 202 using conventional wireless techniques, e.g., infrared (IR) or radio frequency (RF), to change the channel being displayed, to adjust the volume, etc.

In the illustrated embodiment, the remote control 204 includes a microphone 208 for capturing sound waves and generating an analog or digital audio signal. Optionally, the remote control 204 may include a digital video camera 209, such as a color or monochromatic charge-coupled device (CCD) camera, for generating an analog or digital video signal.

In one embodiment, operation of the microphone 208 and/or camera 209 is controlled by a specifically-designated microphone/camera button 206 on the remote control 204. Alternatively, one or more specifically-designated sequences of buttons may be used to activate the microphone 208 and/or camera 209. For example, as described in greater detail below, the remote control 204 may include one or more navigation buttons 207 (up, down, left, right, OK) for selectively activating an on-screen buttons or other control.

In the illustrated embodiment, the remote control 204 further includes a transmitter 210, such as a radio frequency (RF) transmitter. In alternative embodiments, the transmitter 210 may be configured to use infrared (IR), microwave, VHF, UHF, or other frequencies along the electromagnetic spectrum.

In one implementation, the transmitter 210 is in electrical communication with the microphone 208 and/or camera 209 to receive a captured audio and/or video signal. The transmitter 210 preferably modulates the audio and/or video signal with a carrier frequency to enable transmission thereof to the STB 102 using techniques well known in the art. For example, the transmitter 210 may operate according to the IEEE 802.11a or 802.11b Wireless Networking standards, the “Bluetooth” standard, or according to other standard or proprietary wireless techniques. Modulation techniques may include spread spectrum, frequency shift keying, multiple carrier, or other techniques known in the art.

To achieve modulation and transmission, the transmitter 210 may include various additional components not specifically illustrated but well known in the art. For example, the transmitter 210 may include a source encoder to reduce the amount of bandwidth required, a channel encoder to modulate the audio signal with a carrier wave, and a directional or non-directional transmission antenna. The transmitter 210 may further include an amplifier to increase the transmission signal strength to an appropriate power level.

In one configuration, the transmitter 210 is a high-bandwidth transmitter capable of sending the audio and/or video signal to the STB 102 in real-time. The transmitter 210 may use wideband frequency modulation over a frequency band to provide a one-way audio/video link from the remote control 204 to the STB 102. For example, frequency band may be within the 890-960 MHz range (GSM), 1990-2110 MHz range or 2400-2500 MHz range or other frequency ranges as approved by FCC regulations.

In another embodiment, the transmitter 210 utilizes a frequency division multiplexing (FDM) technique in order to transmit several streams of data simultaneously. These streams may be reassembled at the STB 102 to derive the encoded audio and/or video signal. Various other techniques for providing a high bandwidth in multimedia transmissions may also be used within the scope of the invention.

In one embodiment, the transmitter 210 is configured to broadcast digitally-encoded signals. As such, the transmitter 210 may include an analog-to-digital converter (ADC) to convert analog audio/video signals into digital signals.

In accordance with one embodiment, the transmitter 210 comprises an integrated RF antenna (linear or otherwise configured) etched onto the main printed circuit board of the remote control 204. Integration of the antenna with the remote control's circuit board provides for compactness and efficiency in manufacture.

In various embodiments, the remote control 204 is also in electrical communication with a processor (such as a microprocessor, DSP, or the like) that senses a user's operation of the buttons of the remote control 204 and generates appropriate command signals for transmission to the STB 102 and television 202 in order to control the operation of the same.

In the illustrated embodiment, the STB 102 includes an receiver 212, such as an RF receiver, for receiving signals from the transmitter 210 in the remote control 204. The receiver 212 may demodulate audio and/or video signals from the modulated band transmitted by the remote control 204. In various embodiments, the receiver 212 may be configured to receive IR, microwave, VHF, UHF, or other frequencies.

The receiver 212 may further include components not specifically illustrated but well known in the art. For example, the receiver 212 may include an antenna for receiving the transmission, an amplifier for increasing the strength of the received signal, and a decoder for separating and demodulating the audio/video signal from the carrier signal, and the like.

In one implementation, the receiver 212 is in electrical communication with a converter 214, which converts the audio and/or video signal into a digital audio and/or video stream compatible with transmission over the network 103. The converter 214 may include a codec (coder/decoder) for encoding/decoding the audio and/or video signal using various standard methods, such as MPEG, VolP, or the like.

The converter 214 may include network interface circuitry for interfacing with the network 103. For instance, the converter 214 may conform to the DOCSIS (Data Over Cable Service Interface Specification) or DAVIC (Digital Audio-Visual Council) cable modem standards. Alternatively, the converter 214 may include DSL or other types of modem circuitry.

As noted above, the converter 214 is in electrical communication with a broadcast center 104 in order to transmit the network-compatible audio/video stream to one or more other STBs 102 in the network 103. The converter 214 is further configured to receive network-compatible audio/video streams from the network 103 and transform the same into audio/video signals for playback on the television 202 or a speaker 216 integrated with the STB 102.

In the case of a cable network 103, one or more frequency bands (for example from 5 to 30 MHz) may be reserved for upstream transmission. Digital modulation (for example, quadrature amplitude modulation or vestigial sideband modulation) may be used to send digital signals in the upstream transmission. Upstream transmission will be accomplished differently for different networks 100. Alternative ways to accomplish upstream transmission include an analog telephone line, ISDN, DSL, and the like.

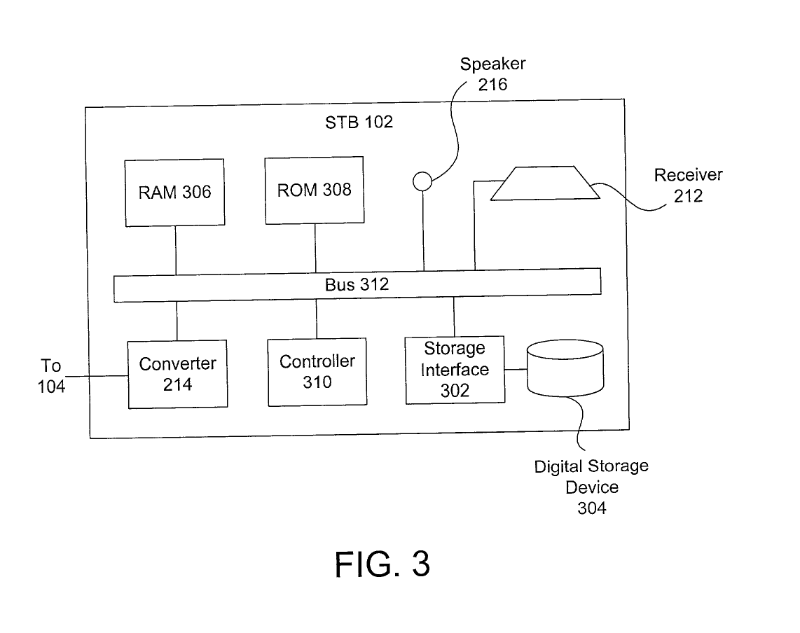

Referring to FIG. 3, there is shown an expanded block diagram of an STB 102 according to an embodiment of the invention. The STB 102 may include a storage interface 302, which provides access to a digital storage device 304, such as a hard disk drive, compact flash device, or the like. In one embodiment, the storage interface 302 receives audio and/or video signals from the receiver 212 and delivers the same to the digital storage device 304 for storage. The audio and/or video signals may be stored in MPEG (MP3) format or other encoded file formats. Alternatively, the audio and/or video signals may be converted by the converter 214 into a network-compatible audio stream before being stored in the storage device 304.

The STB 102 may further include a random access memory (RAM) 306 configured to store data for temporary use. Similarly, a read-only memory (ROM) 308 may be provided for storing more permanent data, such as fixed code and configuration information. In one embodiment, the ROM 308 may be used to store an operating system for the STB 102, such as Windows CE® or Linux®.

The STB 102 preferably includes a controller 310 that is in communication with the receiver 212, the converter 214, the storage interface 302, the RAM 306, the ROM 308, the converter 214, and the speaker 216. The controller 310 may be coupled to the other components of the STB 102 via a bus 312.

In various embodiments, the controller 310 may be embodied as a microcontroller, a microprocessor, a digital signal processor (DSP) or other device known in the art. The controller 310 manages the operation of the STB 102, including, for example, converting audio/video signals, storing audio/video signals, transmitting and receiving audio/video signals from the network 103, and the like. As noted above, the controller 310 may perform these and other operations based on control signals generated by the remote control 204 and transmitted to the receiver 212.

As described in greater detail below, the audio and/or video signal may be converted, compressed and transmitted across the network 103 to one or more other STBs 102 where it is played back on corresponding televisions 202 or speakers 216. In one embodiment, a user may select which STB(s) 102 will receive an audio transmission by entering or selecting one or more addresses of the receiving STB(s) 102 using the remote control 204. As noted above, the address of an STB 102 uniquely identifies the STB 102 within the network 103 and is used by the broadcast centers 104, network 103, and/or the Internet 106 to route a network-compatible audio/video stream to the appropriate STB 102 using conventional techniques.

In various embodiments, an STB 102 may simultaneously send and receive multiple audio streams. In this manner, audio/video conferencing of multiple networked interactive television systems 200 is enabled.

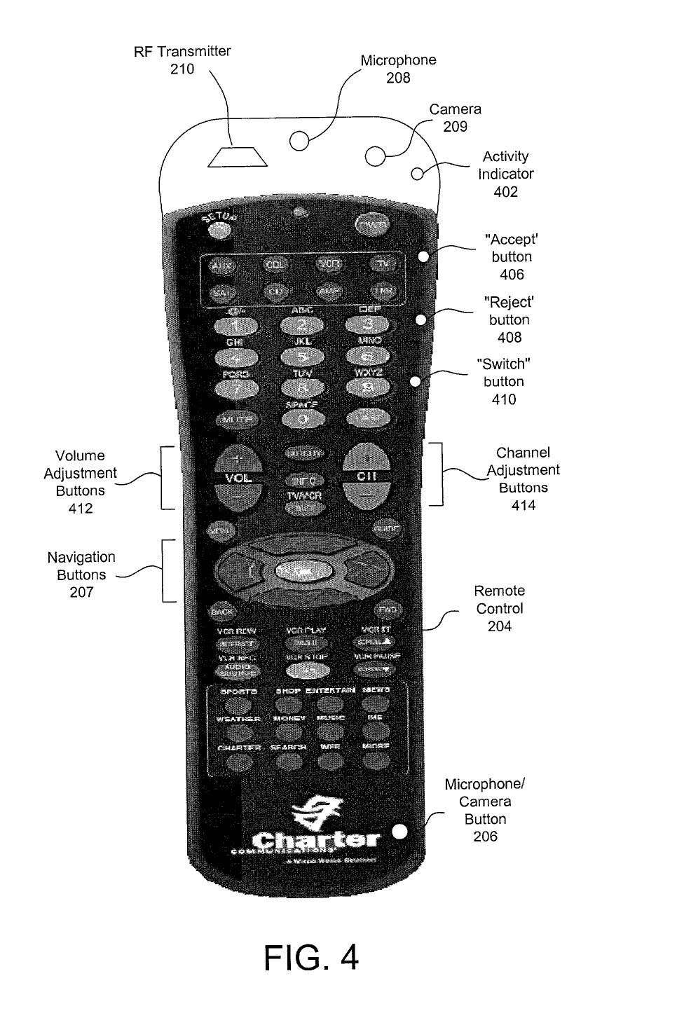

FIG. 4 provides an expanded view of the remote control 204, including the microphone 208, the transmitter 210, the microphone/camera button 206, and the navigation buttons 207. In addition, FIG. 4 illustrates an activity indicator 402, which illuminates or otherwise signals the user when the microphone 208 and/or camera 209 is active. The activity indicator 402 may be embodied as an LED (light-emitting diode) or other suitable indicator.

As illustrated, the remote control 204 may include a number of other buttons or controls, such as an “accept” button 406, a “reject” button 408, and a “switch” button 410, the functions of which are described below. The remote control 204 may also include various standard buttons for controlling an interactive television system 200, such as one or more volume adjustment buttons 412, channel adjustment buttons 414, and the like. Those skilled in the art will recognize that the various components of the remote control 204 may be positioned in different locations for ergonomics and convenience.

As previously noted, both the remote control 504 and the STB 502 may include a microphone 208 and/or camera 209, in addition to the microphone and/or camera 209 provided by the remote control 204. In such an embodiment, a user may select between the STB-based and remote-based microphone 208 and/or camera by means of the “switch” button 410 depicted in FIG. 4. Thus, a user may conveniently switch between fixed and mobile microphones 208 and cameras 209.

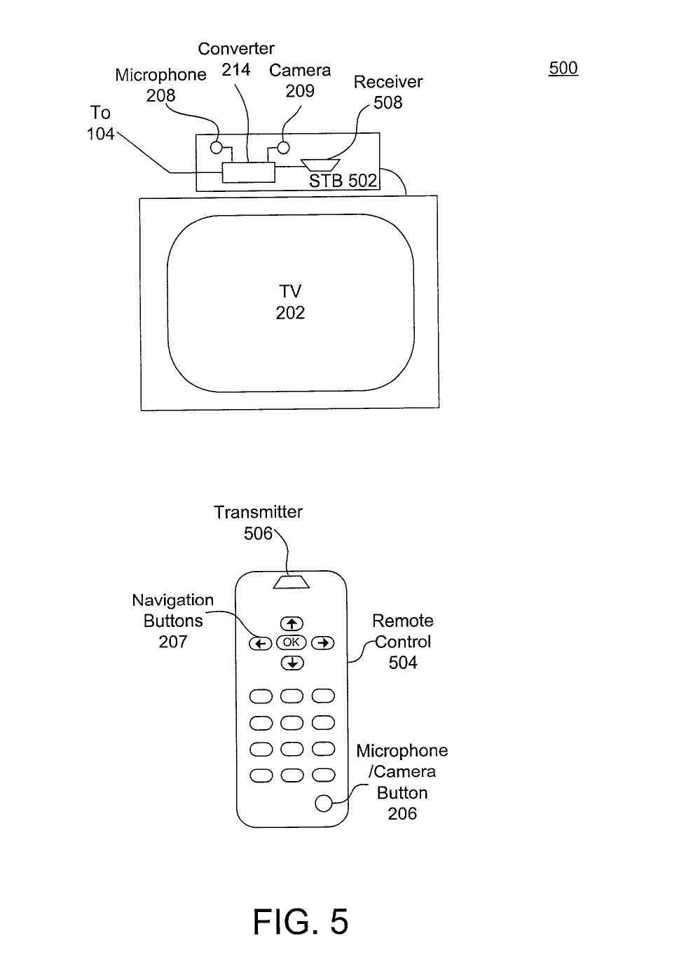

Referring now to FIG. 5, there is shown an interactive television system 500 according to an alternative embodiment of the invention. The television system 500 differs primarily from the television system 200 of FIG. 2 in that the microphone 208 and optional video camera 209 are included within the STB 502, itself, rather than a remote control 504. In yet another alternative embodiment, the microphone 208 and/or camera 209 may be included within both the STB 502 and the remote control 504.

In the depicted embodiment, the remote control 504 includes a transmitter 506, such as an IR transmitter, for sending control signals to a suitable receiver 508 within the STB 502 and/or the television 202. In alternative embodiments, however, the transmitter may use RF, VHF, UHF, microwave, or other frequencies.

In one implementation, the remote control 504 also includes a microphone/camera button 206 for remotely activating the microphone 208 and/or camera 209 disposed within the STB 502. In alternative embodiments, as shown in FIG. 9, a button sequence entered, for example, via the navigation buttons 207 may be used to select a specifically designated on-screen control 902 or menu item for activating the microphone 208 and/or camera 209. In certain embodiments, more than one button sequence may be used to activate the specifically-designated onscreen control 902. For example, depending on which menu or control is currently highlighted, a different sequence of buttons may be required.

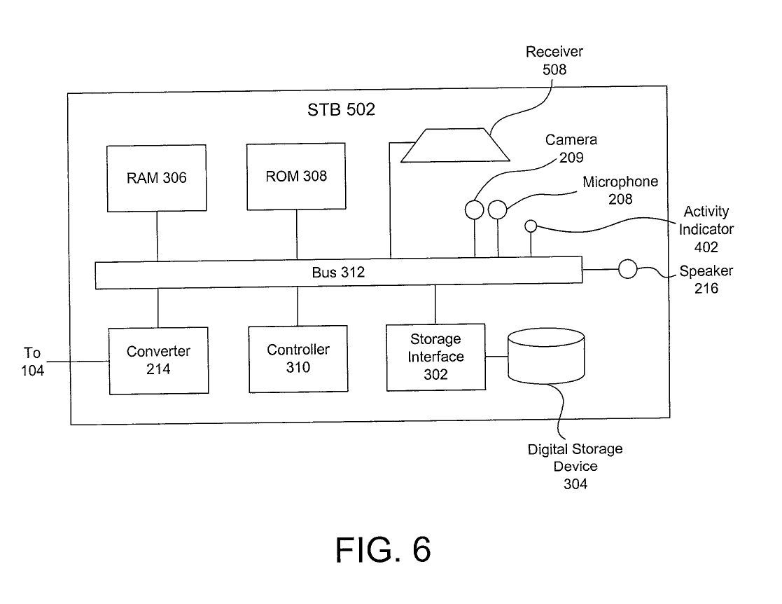

Referring to FIG. 6, there is shown an expanded block diagram of the STB 502. The converter 214, the speaker 216, the storage interface 302, the digital storage device 304, the RAM 306, the ROM 308, and the controller 310 function as previously described with reference to FIG. 3. However, the STB 502 is depicted as including a microphone 208 and/or video camera 209, each of which are depicted as being in communication with the bus 312. Of course, various standard interface circuitry (not shown) may be provided for interfacing the microphone 208 and/or camera 209 with the bus 312. In addition, the STB 502 is depicted as including an activity indicator 402 for visually indicating to a user when the microphone 208 and/or camera 209 are active.

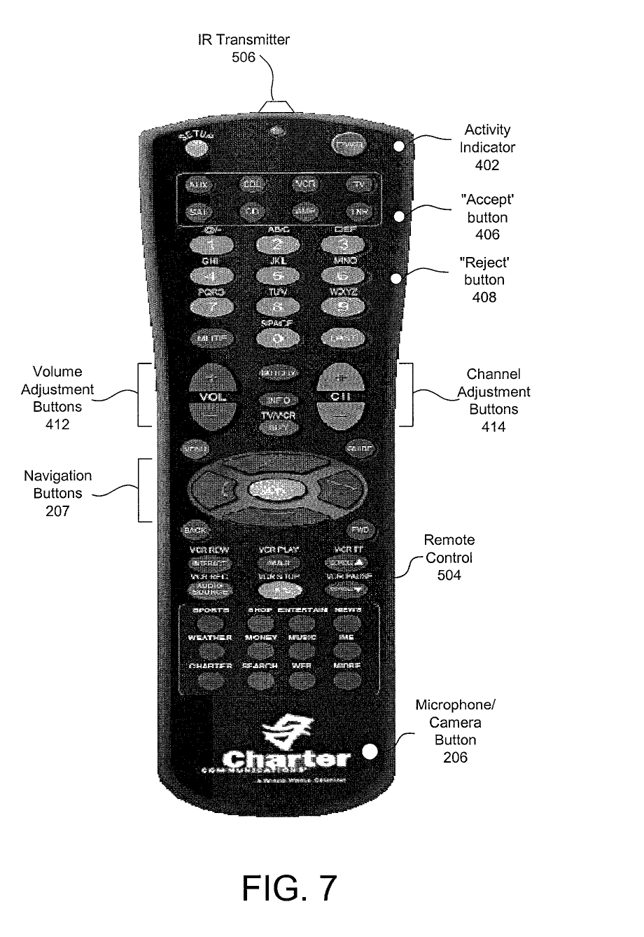

FIG. 7 provides an expanded view of the remote control 504, including the transmitter 506, the microphone/camera button 206, the “accept” button 406, the “reject” button 408, the navigation buttons 207, the volume adjustment buttons 412, and the channel adjustment buttons 414. The remote control 504 may also include a separate activity indicator 402 in addition to the indicator 402 in the STB 502. Those skilled in the art will recognize that the various components of the remote control 504 may be positioned in different locations for convenience and ergonomics.

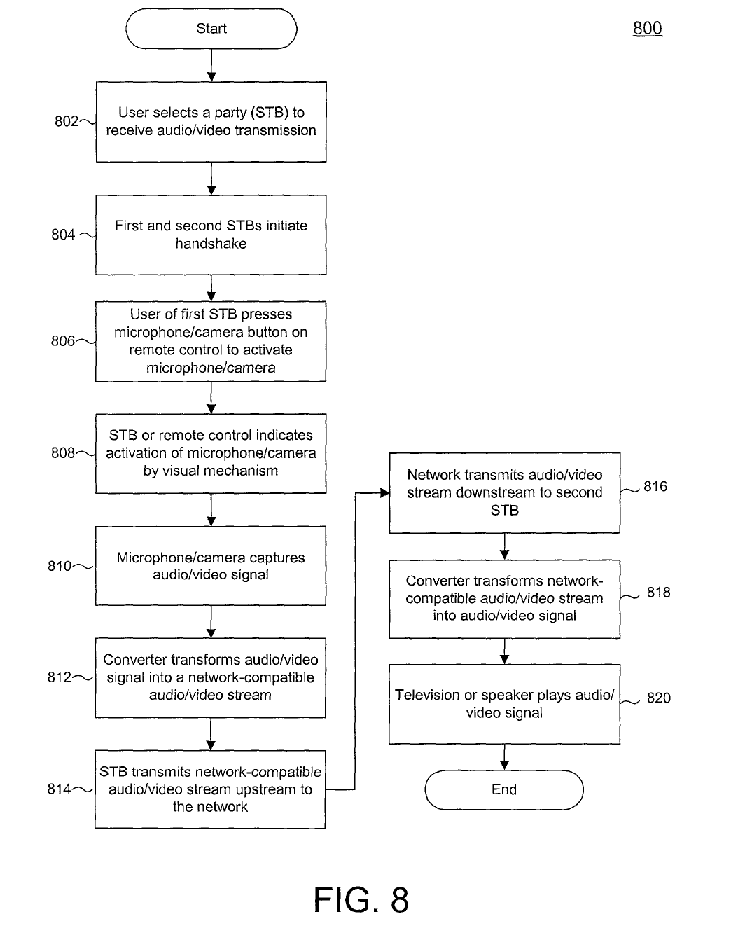

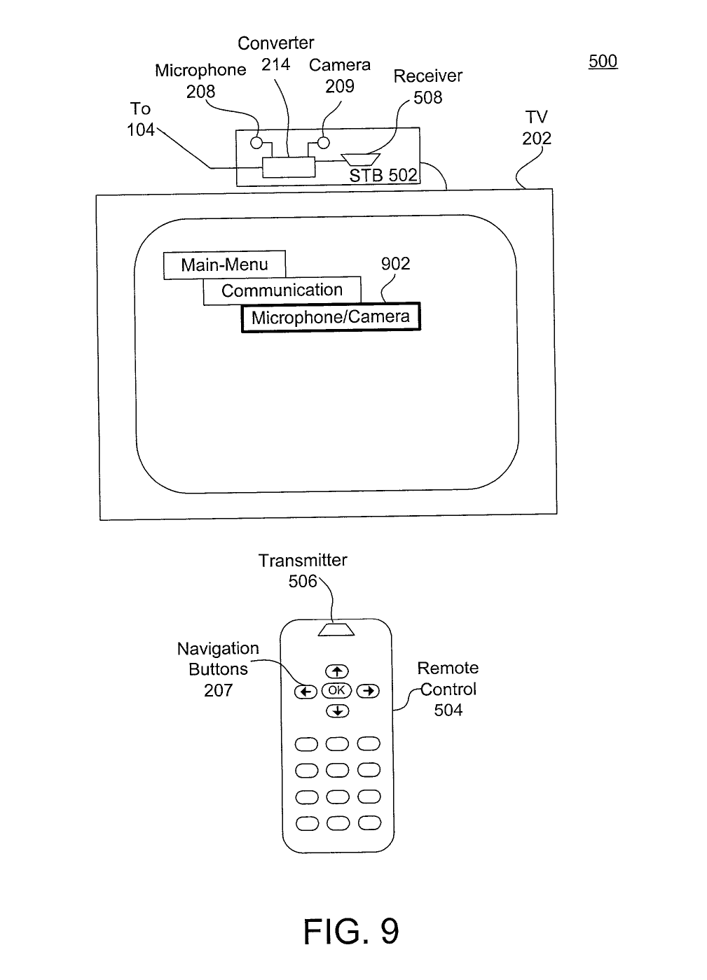

FIG. 8 is a flowchart of a method 800 for audio and video capture and communication according to an embodiment of the invention. The method 800 begins when a user of a first STB 102 selects 802 a second STB 102 (or set of STBs 102) in the network 103 to receive an audio and/or video transmission. The selection may be performed by entering or selecting an identification of the second STB 102 or a user thereof by means the remote control 204. If a user's name is specified, for example, the first STB 102 may access a name server or directory (not shown) to retrieve a corresponding address of the second STB 102. In one embodiment, the first STB 102 may contain a local directory of addresses to which the user frequently sends audio and/or video transmissions.

Once the first STB 102 has a valid address, it sends a request across the network 103 to the second STB 102. The precise format of the request is not crucial to the invention, but the request should indicate to the second STB 102 that the user of the first STB 102 desires to send an audio/video transmission.

In response to the request, the second STB 102 generates a notification, such as a text message or icon, for display on the corresponding television 202 to notify the user of the second STB 102 of the audio/video transmission. Alternatively, the notification may take the form of an audio signal that is played on a speaker 216 in the second STB 102 or in the television 202.

If the second STB 102 is off-line or otherwise not available, the first STB 102 may wait until a timeout period has expired, after which it notifies the user that the audio/video transmission cannot be sent. Likewise, if the user of the second STB 102 does not respond, or refuses to receive the transmission (by means of the “reject” button 408 of FIG. 4, for example) a not-available signal may be returned to the first STB 102.

If the user of the second STB 102 wishes to receive the audio transmission, he or she may press a suitable button the remote control 204, such as the “accept” button 406 of FIG. 4, which results in an acceptance signal being returned to the first STB 102. In one embodiment, the first STB 102 generates, in response to receiving the acceptance signal, an acceptance message to notify the user that permission for the audio/video transmission has been granted.

The first and second STBs 102 may then initiate 804 a handshake procedure to establish a communication protocol. Such a handshake procedure may have some similarity with handshake procedures performed between facsimile (fax) machines. In this case, the STBs 102 may negotiate a new protocol or reaffirm an existing protocol for audio/video communication. The appropriate protocol may need to be determined because the two STBs have different audio/video conferencing capabilities. For example, the second STB may be capable of audio/video conferencing at a lower sound quality, so the communication protocol would be established as is suitable to this lower quality. The communication protocol used may also depend on the bandwidth and/or reliability of the connection between the two STBs 102. At this point, an active communication link is established between the STBs 102 across the network 103.

In one embodiment, the first user then activates 806 the microphone 208 and/or video camera 209 by pressing, for example, the microphone/camera button 206. Of course, the button 206 may be initially pressed to begin the communication process, with an audio/video signal being captured only when communication has been established.

In one implementation, the remote control 204 and/or STB 102 indicates 808 activation of the microphone 208 by a visual mechanism, such as an activity indicator 402 (e.g., LED). Thereafter, the microphone 208 and/or video camera 209 captures 810 an audio and/or video signal, which is transmitted to the STB 102 in the case of the remote control 204 of FIG. 2.

The converter 214 within the STB 102 then transforms 812 the captured audio and/or video signal into a network-compatible audio stream for transmission over the network 103. Thereafter, the network-compatible audio stream is transmitted 814 upstream to the network 103. As noted with reference to FIG. 1, the communication path for the transmission may involve one or more broadcast centers 104 and networks using conventional routing techniques.

In one embodiment, the network-compatible audio and/or video stream is then transmitted 816 downstream from the network 103 to the second STB 102. Thereafter, the network-compatible audio and/or video stream is transformed 818 into audio and/or video signal for playback 820 on the television 202 or the speaker 216 integrated with the STB 102.

In a like manner, the second STB 102 may transmit an audio and/or video signal to the first STB 102. Indeed, in one embodiment, multiple audio and/or video streams may be received and transmitted simultaneously by one or more STB 102. Multiple audio and/or video streams received by an STB 102 may be mixed for playback on the television 202 or the speaker 216 using conventional techniques. Thus, audio/video conferencing between two or more users of networked interactive television systems 200 is enabled.

Of course, the above-described method 800 is only one possible technique for audio and video capture and communication within the scope of the invention. In alternative embodiments, the first STB 102 may transmit an audio/video stream to the second STB 102 without waiting for an acceptance signal. The second STB 102 may record all incoming transmissions in the digital storage device 304. Thereafter, a user of the second STB 102 may review the stored audio/video streams and select which stream, if any, to play at a convenient time.

In yet another alternative embodiment, the first STB 102 may be pre-configured to transmit audio/video signals to a second STB 102, which has previously granted permission to receive the transmission. Accordingly, a user of the first STB 102 may simply press the microphone/camera button 206 to immediately capture audio/video signals and transmit the same to the second STB 102 for immediate playback.

Alternatively, the audio/video conferencing may occur between the first STB 102 and a client terminal more generically (not just a second STB 102). The client terminal may comprise a phone, personal computer or other device with a connection to the Internet 106, telephone network 108, or to a broadcast center 104. Such other devices may include telephones, cellular phones, Internet appliances (e.g., webpads), personal digital assistants (PDAs), and the like.

In view of the forgoing, the present invention offers numerous advantages not available in the prior art. By integrating a microphone 208 and/or camera 209 with a remote control 204 for an interactive television system 200, a user may easily converse during a television broadcast with one or more other users at remote physical locations with minimal disruption of the television program and in a cost-effective manner. Moreover, by providing a specifically-designated button or sequence of buttons for activating the microphone 208 and/or camera 209, a user may quickly and efficiently capture audio/video events of interest.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A system for enabling communication between multiple individuals during television broadcasts, the system comprising:
a set top box for an interactive television system for selectively receiving a television signal;
a microphone integrated with the set top box for capturing an audio signal; and
a remote control for the interactive television system comprising at least one specifically-designated button sequence for activating the microphone.

2. The system of claim 1, wherein the remote control comprises at least one navigation button for entering the at least one specifically-designated button sequence.

3. The system of claim 1, wherein the set top box is configured to display on a television an on-screen control for activating the microphone, and wherein the at least one specifically-designated button sequence is configured to activate the onscreen control.

4. The system of claim 1, wherein the set top box comprises an activity indicator for visually indicating when the microphone is active.

5. The system of claim 1, wherein the remote control comprises an activity indicator for visually indicating when the microphone is active.

6. The system of claim 1, wherein the set top box comprises a digital recording device for recording the audio signal captured by the microphone.

7. The system of claim 1, wherein the set top box comprises a converter for transforming the audio signal captured by the microphone into a network-compatible audio stream for transmission over a network.

8. The system of claim 1, further comprising:
a video camera integrated with the set top box for capturing a video signal, wherein the remote control comprises at least one specifically-designated button sequence for activating the video camera.

9. The system of claim 8, wherein the set top box comprises an activity indicator for visually indicating when the video camera is active.

10. The system of claim 8, wherein the remote control comprises an activity indicator for visually indicating when the video camera is active.

11. The system of claim 8, wherein the set top box comprises a digital recording device for recording the video signal captured by the video camera.

12. The system of claim 8, wherein the set top box comprises a converter for transforming the video signal captured by the video camera into a network-compatible audio stream for transmission over a network.

13. The system of claim 1, wherein the set top box comprises a converter for transforming a network-compatible audio stream received from a remote system into an audio signal suitable for output by a speaker.

14. The system of claim 13, wherein the set top box comprises a speaker for outputting the transformed audio signal.

15. The system of claim 1, wherein the set top box comprises a converter for transforming a network-compatible video stream received from a remote system into a video signal suitable for display on a television.

16. A system for enabling communication between multiple individuals during television broadcasts, the system comprising:
a set top box for an interactive television system for selectively receiving a television signal, the set top box comprising:
a microphone for capturing an audio signal; and
a display controller for displaying on a television a specifically-designated on-screen control for activating the microphone; and
a remote control for the interactive television system comprising at least one button for selectively activating the specifically-designated on-screen control.

17. The system of claim 16, wherein the at least one button on the remote control comprises a navigation button.

18. The system of claim 16, wherein the set top box comprises an activity indicator for visually indicating when the microphone is active.

19. The system of claim 16, wherein the remote control comprises an activity indicator for visually indicating when the microphone is active.

20. The system of claim 16, wherein the set top box comprises a digital recording device for recording the audio signal captured by the microphone.

21. The system of claim 16, wherein the set top box comprises a converter for transforming the audio signal captured by the microphone into a network-compatible audio stream for transmission over a network.

22. The system of claim 16, wherein the set top box comprises a video camera for capturing a video signal, and wherein the display controller is further configured to display on the television a specifically-designated on-screen control for activating the video camera.

23. The system of claim 22, wherein the set top box comprises an activity indicator for visually indicating when the video camera is active.

24. The system of claim 22, wherein the remote control comprises an activity indicator for visually indicating when the video camera is active.

25. The system of claim 22, wherein the set top box comprises a digital recording device for recording the video signal captured by the video camera.

26. The system of claim 22, wherein the set top box comprises a converter for transforming the video signal captured by the video camera into a network-compatible audio stream for transmission over a network.

27. The system of claim 16, wherein the set top box comprises a converter for transforming a network-compatible audio stream received from a remote system into an audio signal suitable for output by a speaker.

28. The system of claim 27, wherein the set top box comprises a speaker for outputting the transformed audio signal.

29. The system of claim 16, wherein the set top box comprises a converter for transforming a network-compatible video stream received from a remote system into a video signal suitable for display on the television.

30. A system for enabling communication between multiple individuals during television broadcasts, the system comprising:
means for selectively receiving a television signal;
means, integrated with the selectively receiving means, for capturing an audio signal; and
means for remotely controlling the selectively receiving means comprising at least one specifically-designated button sequence for activating the audio signal capturing means.

31. A system for enabling communication between multiple individuals during television broadcasts, the system comprising:
means for selectively receiving a television signal comprising:
means for capturing an audio signal; and
means for displaying on a television a specifically-designated onscreen control for activating the audio signal capturing means; and
means for remotely controlling the interactive television system comprising at least one button for selectively activating the specifically-designated on-screen control.
